(19) United States
(12) Patent Application Publication
(10) Pub. No.: US 2019/0048290 A1
(43) Pub. Date: Feb. 14, 2019

(54) AUTOMATIC DISHWASHING COMPOSITION

(71) Applicant: The Procter & Gamble Company, Cincinnati, OH (US)

(72) Inventors: Karen Margaret PRESTON, Newcastle upon Tyne (GB); Michael VAN WASSENHOVEN, Affligem (BE); Philip Frank SOUTER, Northumberland (GB); Rachel Elizabeth MARTIN, Newcastle upon Tyne (GB)

(21) Appl. No.: 16/059,062

(22) Filed: Aug. 9, 2018

(30) Foreign Application Priority Data
Aug. 11, 2017 (EP) 17186017.4

(51) Int. Cl. C11D 3/37; C11D 3/386; C11D 3/20; C11D 3/12; C11D 3/39; C11D 3/395; C11D 11/00

(52) U.S. Cl. CPC C11D 3/3757; C11D 3/386; C11D 3/2082; C11D 11/0035; C11D 3/3905; C11D 3/395; C11D 3/1233

(57) ABSTRACT

A phosphate-free automatic dishwashing cleaning composition including a partially decarboxylated polyitaconic acid homopolymer.

### TECHNICAL FIELD

The present invention is in the field of cleaning. It relates to a cleaning product, in particular, it relates to a phosphate-free automatic dishwashing cleaning composition comprising a partially decarboxylated itaconic acid homopolymer. The composition provides good cleaning and finishing.

### BACKGROUND OF THE INVENTION

Automatic dishwashing detergents have been in the market for nearly a century now. Environmental regulations in terms of cleaning ingredients and energy requirements have changed over time. Automatic dishwashing detergents are continuously improving but still the detergents available do not seem to be effective under all conditions. Failures on the washed items are still found.

The design of an automatic dishwashing detergent is not straight forward. Users expect good cleaning and at the same time good finishing (lack of filming and spotting, and shine) of the washed items. Some cleaning actives such as alkaline metal carbonates are very good in terms of soil removal but they are believed to have a negative effect on filming, spotting and/or shine and/or they can damage the washed surfaces.

Chelation is crucial in automatic dishwashing. Chelation is the process by which calcium and other heavy metals are sequestered. In automatic dishwashing calcium and other heavy metals can be found as part of the hardness of the water or as part of the soils found in the dishwashing load. Builders play an important role in chelation in automatic dishwashing. Many different variables affect builder performance in automatic dishwashing. The binding calcium capacity of the builder is one of the variables that affect the builder performance but it is not the only one. The binding calcium capacity of a builder depends on several factors such as temperature, pH, ionic strength, etc. How the calcium binding capacity changes with these factors seems to be different for each builder. The solubility and suspension capacities of the builder also need to be considered, as well as the size, stearic configuration, electrical charge, etc.

Even when a strong chelating builder is added at a level to bind all the calcium in the wash liquor, crystals of calcium carbonate still form and grow having a detriment effect on shine. Several known crystal growth inhibitors contain high levels of phosphorus, something which is not desirable given the environmental profile of such materials.

All in all, it is not straight forward to design a well performing automatic dishwashing detergent, especially if environmental concerns are taken into account.

### SUMMARY OF THE INVENTION

According to the first aspect of the invention, there is provided a phosphate-free automatic dishwashing cleaning composition. By “phosphate-free” is herein understood that the composition comprises less than 1%, preferably less than 0.1% by weight of the composition of phosphate. The composition comprises a partially decarboxylated polyitaconic acid homopolymer. The homopolymer acts as a crystal growth inhibitor.

The composition provides good cleaning, in particular, good finishing, more in particular good glass and plastic clarity. The composition is environmentally friendly due to the biodegradability of the homopolymer.

By “itaconic homopolymer” is herein meant a polymer comprising monomer units derived from itaconic acid and/or its salts. The “itaconic homopolymer” is sometimes herein referred to as “the homopolymer” of the invention.

Preferably, the level of decarboxylation of the polyitaconic acid homopolymer is at or above 40 mole % of carbon dioxide evolved per molar equivalent of itaconic acid in said homopolymer based upon a maximum level of decarboxylation of 200 mole %, more preferably the level of decarboxylation is in the range of 40 mole % to 150 mole % and especially in the range of 50 mole % to 90 mole %.

Preferably the homopolymer has a weight average molecular weight of from about 500 g/mole to 10,000 g/mole, more preferably from 800 g/mole to 5,000 g/mole. Especially preferred homopolymers for use herein have a level of decarboxylation in the range of 50 mole % to 90 mole % and an average molecular weight of from 800 g/mole to 5,000 g/mole.

The composition preferably comprises an alkaline-metal carbonate. High levels of alkaline-metal carbonates have been found to be very effective in automatic dishwashing. A drawback associated with high carbonate levels, however, is that calcium ions present in the washing water readily form precipitates with the carbonate that can give rise to filming and spotting.

The composition preferably comprises an alkali metal carbonate and a complexing agent. Preferably the pH of the composition as measured in a 1% weight/volume aqueous solution in distilled water at 20° C. is greater than 10.

According to the second aspect of the invention, there is provided a method of automatic dishwashing using the composition of the invention.

According to the third aspect of the invention, there is provided the use of a partially decarboxylated polyitaconic acid homopolymer in an automatic dishwashing cleaning composition to improve glass and plastic clarity in an automatic dishwashing process. Especially good results are obtained on glass clarity.

The elements of the composition of the invention described herein apply mutatis mutandis to the use and method aspects of the invention.

### DETAILED DESCRIPTION OF THE INVENTION

The present invention provides an automatic dishwashing cleaning composition comprising partially decarboxylated polyitaconic acid homopolymer in an automatic dishwashing cleaning composition to improve glass and plastic clarity in an automatic dishwashing process. There is also provided a method of automatic dishwashing using the composition and the use of the composition to improve glass and in particular plastic clarity in automatic dishwashing.

As used herein, articles such as “a” and “an” are understood to mean one or more of what is claimed or described.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

### Automatic Dishwashing Cleaning Composition

The composition comprises a partially decarboxylated polyitaconic acid homopolymer and optionally but preferably a complexing agent, a dispersant polymer, bleach, inorganic builder (preferably carbonate), enzymes in particular proteases and amylases, non-ionic surfactant, etc.

The composition of the invention preferably has a pH as measured in 1% weight/volume aqueous solution in distilled water at 20° C. of from at least 10, more preferably at least 10.5.

The composition of the invention preferably has a reserve alkalinity of from about 10 to about 20, more preferably from about 12 to about 18 at a pH of 9.5 as measured in NaOH with 100 grams of product at 20° C. “Reserve alkalinity”, as used herein refers to, the ability of an automatic dishwashing composition to maintain an alkali pH in the presence of acid. This is relative to the ability of an automatic dishwashing composition to have sufficient alkali in reserve to deal with any added acid coming from the water and/or the soils on the dishware-while maintaining the pH.

More specifically, it is defined as the grams of NaOH per 100 cc's, exceeding pH 9.5, in product. The reserve alkalinity for a solution is determined in the following manner.

A pH meter (for example An Orion Model 720A) with a Ag/AgCl electrode (for example an Orion sure flow Electrode model 9172BN) is standardized using pH 7 and pH 10 buffers. A 1% solution of the composition to be tested is prepared in distilled water. The weight of the sample is noted. The pH of the 1% solution is measured and the solution is titrated down to pH 9.5 using a solution of 0.2N HCL. The reserve alkalinity is calculated in the following fashion:

Reserve Alkalinity=% NaOH×Specific Gravity.

% NaOH=ml HCl×Normality of HCl×4′/Weight of Sample Aliquot Titrated

* Equivalent weight of NaOH in the % NaOH equation,

derived from:

% NaOH=ml HCl×Normality of HCl×Equiv. Weight NaOH×100/1000×Weight of Sample Aliquot Titrated.

### Itaconic Homopolymer

The polymer comprises monomer units derived from itaconic acid. The polymer comprises pendant carboxylic acid groups that are partially decarboxylated and carboxylic acid groups, some of which are in the metallic salt form.

Polyitaconic acid can have two carboxylic acids groups per repeat unit, the amount of decarboxylation may therefore theoretically be 200 mole % (i.e. 200 mole % of carbon dioxide may be evolved per molar equivalent of itaconic acid in the polymer). In the present disclosure, the level of decarboxylation is controlled such that it is above 30 mole % and preferably falls in the range of 40 mole % to 150 mole % of carbon dioxide evolved per molar equivalent of itaconic acid in the polymer. Preferably, the level of partial decarboxylation herein is

configured to ultimately fall within the range of 45 mole %
to 100 mole % of carbon dioxide evolved per molar equivalent
of itaconic acid in the polymer, and most
preferably in the range of 50 mole % to 90 mole % of carbon
dioxide evolved per molar equivalent of carbon dioxide in
the polymer.

Preferably, the polymer has a weight average molecular weight of from about 500 g/mole to about 10,000 g/mole, preferably from about 800 g/mole to about 5,000 g/mole. Preferably the polymer has a number average molecular weight of from about 500 g/mole to about 10,000 g/mole, preferably from about 800 g/mole to about 5,000 g/mole.

The polymer can be manufactured following the method of preparation described in U.S. Pat. No. 9,487,423 B1. Especially preferred polymer for use herein is Itaconix TSI® provided by Itaconix.

The homopolymer is preferably present in an amount ranging from 0.1 to 5%, more preferably from 0.2 to 2% by weight of the composition. The homopolymer can be added to the automatic dishwashing composition in liquid or solid form, for example in the form of a particle.

### Complexing Agent

A complexing agent is a material capable of sequestering hardness ions, particularly calcium and/or magnesium. The complexing agent is preferably selected from the group consisting of citric acid and its salts, methyl-glycine-diacetic acid (MGDA) and its salts, glutamic-N,N-diacetic acid and its salts, iminodisuccinic acid and its salts, carboxy methyl inulin and its salts and mixtures thereof. Especially preferred complexing agent for use herein is a salt of MGDA, in particular the tri-sodium salt of MGDA, especially when the composition has a pH greater than 11 as measured in 1% weight/volume aqueous solution in distilled water at 20° C.

The composition of the invention preferably comprises from about 5 to about 50%, more preferably from about 8 to about 40% by weight of the composition of a complexing agent. Preferably the complexing agent comprises the tri-sodium salt of MGDA.

### Dispersant Polymer

The dispersant polymer, if present, is used in any suitable amount from about 0.1 to about 10%, preferably from 0.2 to about 8%, more preferably from 0.3 to 6% by weight of the composition. The dispersant polymer is capable to suspend calcium or calcium carbonate in an automatic dishwashing process.

The dispersant polymer has a calcium binding capacity within the range between 30 to 250 mg of Ca/g of dispersant polymer, preferably between 35 to 200 mg of Ca/g of dispersant polymer, more preferably 40 to 150 mg of Ca/g of dispersant polymer at 25° C. In order to determine if a polymer is a dispersant polymer within the meaning of the invention, the following calcium binding-capacity determination is conducted in accordance with the following instructions:

### Calcium Binding Capacity Test Method

The calcium binding capacity referred to herein is determined via titration using a pH/ion meter, such as the Meettler Toledo SevenMulti™ bench top meter and a PerfectION™ comb Ca combination electrode. To measure the binding capacity a heating and stirring device suitable for beakers or tergotometer pots is set to 25° C., and the ion electrode with meter are calibrated according to the manufacturer's instructions. The standard concentrations for the electrode calibration should bracket the test concentration and should be measured at 25° C. A stock solution of 1000 mg/g of Ca is prepared by adding 3.67 g of CaCl₂-2H₂O into 1 L of deionised water, then dilutions are carried out to prepare three working solutions of 100 mL each, respectively comprising 100 mg/g, 10 mg/g, and 1 mg/g concentrations of Calcium. The 100 mg Ca/g working solution is used as the initial concentration during the titration, which is conducted at 25° C. The ionic strength of each working solution is adjusted by adding 2.5 g/L of NaCl to each. The 100 mL of 100 mg Ca/g working solution is heated and stirred until it reaches 25° C. The initial reading of Calcium ion concentration is conducted at when the solution reaches 25° C. using the ion electrode. Then the test polymer is added incrementally to the calcium working solution (at 0.01 g/L intervals) and measured after 5 minutes of agitation following each incremental addition. The titration is stopped when the solution reaches 1 mg/g of Calcium. The titration procedure is repeated using the remaining two calcium concentration working solutions. The binding capacity of the test polymer is calculated as the linear slope of the calcium concentrations measured against the grams/L of test polymer that was added.

The dispersant polymer preferably bears a negative net charge when dissolved in an aqueous solution with a pH greater than 6.

The dispersant polymer can bear also sulfonated carboxylic esters or amides, in order to increase the negative charge at lower pH and improve their dispersing properties in hard water. The preferred dispersant polymers are sulfonated polymers, i.e., polymer comprising sulfonated monomers.

Preferably, the dispersant polymers are sulfonated derivatives of polycarboxylic acids and may comprise two, three, four or more different monomer units. The preferred copolymers contain: At least one structural unit derived from a carboxylic acid monomer having the general formula

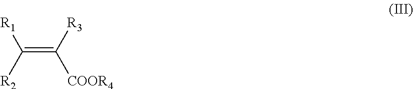

wherein R₁ to R₃ are independently selected from hydrogen, methyl, linear or branched saturated alkyl groups having from 2 to 12 carbon atoms, linear or branched mono or polyunsaturated alkenyl groups having from 2 to 12 carbon atoms, alkyl or alkenyl groups as aforementioned substituted with —NH2 or —OH, or —COOH, or COOR₄, where R₄ is selected from hydrogen, alkali metal, or a linear or branched, saturated or unsaturated alkyl or alkenyl group with 2 to 12 carbons;

Preferred carboxylic acid monomers include one or more of the following: acrylic acid, maleic acid, maleic anhydride, itaconic acid, citraconic acid, 2-phenylacrylic acid, cinnamic acid, crotonic acid, fumaric acid, methacrylic acid, 2-ethylacrylic acid, methylenemalonic acid, or sorbic acid. Acrylic and methacrylic acids being more preferred.

Optionally, one or more structural units derived from at least one nonionic monomer having the general formula (IV):

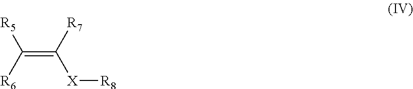

Wherein R₅ to R₇ are independently selected from hydrogen, methyl, phenyl or hydroxyalkyl groups containing 1 to 6 carbon atoms, and can be part of a cyclic structure, X is an optionally present spacer group which is selected from —CH₂—, —COO—, —CONH— or —CONR₈—, and R₈ is selected from linear or branched, saturated alkyl radicals having 1 to 22 carbon atoms or unsaturated, preferably aromatic, radicals having from 6 to 22 carbon atoms.

Preferred non-ionic monomers include one or more of the following: butene, isobutene, pentene, 2-methylpent-1-ene, 3-methylpent-1-ene, 2,4,4-trimethylpent-1-ene, 2,4,4-trimethylpent-2-ene, cyclopentene, methylcyclopentene, 2-methyl-3-methyl-cyclopentene, hexene, 2,3-dimethylhex-1-ene, 2,4-dimethylhex-1-ene, 2,5-dimethylhex-1-ene, 3,5-dimethylhex-1-ene, 4,4-dimethylhex-1-ene, cyclohexene, methylcyclohexene, cycloheptene, alpha olefins having 10 or more carbon atoms such as, dec-1-ene, dodec-1-ene, hexadec-1-ene, octadec-1-ene and docos-1-ene, preferred aromatic monomers are styrene, alpha methylstyrene, 3-methylstyrene, 4-dodecylstyrene, 2-ethyl-4-bezylstyrene, 4-cyclohexylstyrene, 4-propylstyrol, 1-vinylnaphtalene, 2-vinylnaphtalene; preferred carboxylic ester monomers are methyl (meth)acrylate, ethyl (meth)acrylate, propyl (meth)acrylate, t-butyl (meth)acrylate, pentyl (meth)acrylate, hexyl (meth)acrylate, 2-ethylhexyl (meth)acrylate, octyl (meth)acrylate, lauryl (meth)acrylate, stearyl (meth)acrylate and behenyl (meth)acrylate; preferred amides are N-methyl acrylamide, N-ethyl acrylamide, N-t-butyl acrylamide, N-2-ethylhexyl acrylamide, N-octyl acrylamide, N-lauryl acrylamide, N-stearyl acrylamide, N-behenyl acrylamide;

and at least one structural unit derived from at least one sulfonic acid monomer having the general formula (V) and (VI):

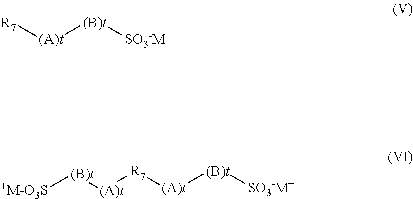

wherein R₇ is a group comprising at least one sp2 bond, A is O, N, P, S, an amido or ester linkage, B is a mono- or polycyclic aromatic group or an aliphatic group, each t is independently 0 or 1, and M+ is a cation. In one aspect, R₇ is a C2 to C6 alkene. In another aspect, R7 is ethene, butene or propene.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

Suitable dispersant polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol, preferably from about 5,000 to about 45,000 g/mol. The dispersant polymer may be a low molecular weight homopolymer of polyacrylate, with an average molecular weight of from 1,000 to 20,000, particularly from 2,000 to 10,000, and particularly preferably from 3,000 to 5,000.

The dispersant polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000 and more preferably from 20,000 to 50,000 and in particular 30,000 to 40,000 g/mol. and a ratio of (meth)acrylate to maleate or fumarate segments of from 30:1 to 1:2.

The dispersant polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such dispersant polymer may have a molecular weight of from 4,000 to 20,000 and an acrylamide content of from 0% to 15%, by weight of the polymer.

Dispersant polymers suitable herein also include itaconic acid homopolymers and copolymers. Alternatively, the dispersant polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

### Bleach

The composition of the invention preferably comprises from about 1 to about 20%, more preferably from about 5 to about 18%, even more preferably from about 8 to about 15% of bleach by weight of the composition.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 0 to about 10%, more preferably from about 0.1 to about 5%, even more preferably from about 0.5 to about 3% by weight of the composition.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition of the invention comprises from 0.01 to 5, preferably from 0.2 to 2% by weight of the composition of bleach activator, preferably TAED.

### Bleach Catalyst

The composition herein might contain a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt(III) and related complexes.

Preferably the composition of the invention comprises from 0.001 to 0.5, more preferably from 0.002 to 0.05% of bleach catalyst by weight of the composition. Preferably the bleach catalyst is a manganese bleach catalyst.

### Inorganic Builder

The composition of the invention preferably comprises an inorganic builder. Suitable inorganic builders are selected from the group consisting of carbonate, silicate and mixtures thereof. Especially preferred for use herein are sodium carbonate and silicate. Preferably the composition of the invention comprises from 5 to 50%, more preferably from 10 to 40% and especially from 15 to 30% of sodium carbonate by weight of the composition.

### Non-Ionic Surfactant

Surfactants suitable for use herein include non-ionic surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Further surfactants may be present in a level of from 0.1 to 10%, more preferably from 0.2 to 5% and especially from 0.3 to 3% by weight of the composition.

### Enzymes

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, 5130A, Y167A, R1705, A194P, V2051 and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+5130A
(iii) N76D+N87R+G118R+S128L+P129Q+5130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the product of the invention include from about 0.1 to about 50, more preferably from about 1 to about 45 and especially from about 10 to about 40 mg of active protease. Protease greatly contribute to the removal of cooked-, baked- and burnt-on soils.

### Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp. 707 (SEQ ID NO:7 in U.S. Pat. No. 6,093,562), especially those comprising one or more of the following mutations M202, M208, 5255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

Preferably, the product of the invention comprises at least 0.01 mg, preferably from about 0.05 to about 10, more preferably from about 0.1 to about 6, especially from about 0.2 to about 5 mg of active amylase.

### Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, amylases, and mixtures thereof.

Preferably, the protease and/or amylase of the product of the invention are in the form of granulates, the granulates comprise less than 29% of sodium sulfate by weight of the granulate or the sodium sulfate and the active enzyme (protease and/or amylase) are in a weight ratio of less than 4:1.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and especially from 0.3 to 3% by weight of the product of a metal care agent, preferably the metal care agent is benzo triazole (BTA).

### Glass Care Agents

Glass care agents protect the appearance of glass items during the dishwashing process. Preferably the composition of the invention comprises from 0.2 to 4% and especially from 0.3 to 3% by weight of the composition of a metal care agent, preferably the glass care agent is a zinc containing material, especially hydrozincite.

The composition of the invention can be in any physical form including solid, liquid and gel form. The composition of the invention is very well suited to be presented in unit-dose form, preferably in the form of a multi-compartment pack, more in particular a multi-compartment pack comprising compartments with compositions in different physical forms, for example a compartment comprising a composition in solid form and another compartment comprising a composition in liquid form. Preferably, the homopolymer is in the form of a particle. The composition if in unit-dose form, is preferably enveloped by a water-soluble film such as polyvinyl alcohol, more preferably the film has a thickness of less than 100 μm.

### EXAMPLES

Two automatic dishwashing formulas were made comprising the ingredients detailed herein below (Composition 1 (comparative) and Composition 2 (according to the invention)).

| Ingredients (g active) | Composition 1 | Composition 2 |
|---|---|---|
| Solid | | |
| MGDA | 5 g | 5 g |
| Partially decarboxylated itaconic | — | 0.5 g |
| homopolymer | | |
| Sulfonated polymer | 1.2 g | 1.2 g |
| Sodium carbonate | 4 g | 4 g |
| Amylase | 8.7 mg | 8.7 mg |
| Protease | 34.6 mg | 34.6 mg |
| Sodium percarbonate | 2 g | 2 g |
| TAED | 1.8 mg | 1.8 mg |
| Miscellaneous | 0.68 g | 0.68 g |
| Liquid | | |
| Plurafac SLF-180 | 0.7 g | 0.7 g |
| Lutensol TO7 | 0.9 g | 0.9 g |
| Miscellaneous | 0.5 g | 0.5 g |

| | |
|---|---|
| MGDA | Tri-sodium salt of methyl glycine diacetic acid. |
| Partially decarboxylated | Itaconix ® TSI710 available from Itaconix |
| itaconic homopolymer | |
| Sulfonated polymer | Acusol 588 available from Dow |
| Amylase | Atlantic ® avalable from Novozymes |
| Protease | Ultimase ® avalable from DuPont |
| TAED | Tetraacetylethylenediamine |
| Plurafac SLF-180 | Nonionic surfactant supplied by BASF |
| Lutensol TO7 | Nonionic surfactant supplied by BASF |
| Inorganic Shine Test | |

A multi-cycle test was carried out using a Maytag dishwasher, in a normal wash 65° C. setting. On each cycle 50 g of soil 1 were added into the dishwasher at the start of the wash. The water hardness was about 130 ppm cations (Ca²⁺, Mg²⁺).

The glasses and plastic tumblers were washed (30 cycles) with Composition 1, outside the scope of the invention and with Composition 2, comprising an itaconic homopolymer according to the invention.

After running 30 consecutives cycles, the glasses and plastic tumblers were then photographed against a black background and the images were analyzed using computer aided software to measure percentage clarity. Clarity index (%) is a calculation of image intensity. The mean film gray level is a measurement of gray level in the range 0-255. The quoted clarity index (%) is the percentage of the way from 0-255. A clarity index of 100 would occur with a completely dark glass with a gray level of zero. A clarity index of 0 would occur with a completely white glass with a gray level of 255. A clarity difference of 2 is significant.

| | Glass Clarity Index at 30 | Plastic Clarity Index at 30 |
|---|---|---|
| Composition | Cycles (%) | Cycles (%) |
| 1 | 75.6 | 71.8 |
| 2 | 79.1 | 88.0 |

Composition 2, according to the invention, provides a better clarity index on both glass and plastic substrates than comparative Composition 1.

### Test Method

Soil 1 is prepared with the following protocol:

| Ingredient | Weight | Tolerance |
|---|---|---|
| City water | 2500 g | ±1 g |
| Smash | 18 g | ±0.2 g |
| Milk full fat UHT | 179 g | ±0.5 g |
| Heinz Tomato Ketchup | 89 g | ±0.5 g |
| Coleman's English Mustard | 89 g | ±0.5 g |
| Bisto gravy | 89 g | ±0.5 g |
| Stork margarine | 357 g | ±1 g |
| Egg yolk | 179 g | ±1 g |
| Total | 3500 g | |

1. Measure the tap water into a pan and heat to −50° C.
2. Add all of the ingredients except margarine to the pan stirring well to avoid lumps.
3. Slowly add the margarine making sure it is broken up into small pieces first.
4. Heat to between 88-90° C., simmering. Then turn the heat to the lowest setting for a further 10 minutes.
5. Allow the mixture to cool to at least 35° C., if not 3500 g in total top up with City water.
6. Stir well then weigh out 50 g batches of this mixture into plastic pots and freeze.
   The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.
   Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.
While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A phosphate-free automatic dishwashing cleaning composition comprising a partially decarboxylated polyitaconic acid homopolymer.

2. A composition according to claim 1 wherein the level of decarboxylation of the polyitaconic acid homopolymer is at or above 40 mole % of carbon dioxide evolved per molar equivalent of itaconic acid in said homopolymer based upon a maximum level of decarboxylation of 200 mole %.

3. A composition according to claim 1 wherein the level of decarboxylation of the polyitaconic acid homopolymer is in the range of about 40 mole % to about 150 mole % of carbon dioxide evolved per molar equivalent of itaconic acid in said homopolymer based upon a maximum level of decarboxylation of 200 mole %.

4. A composition according to claim 1 wherein the level of decarboxylation of the polyitaconic acid homopolymer is in the range of about 50 mole % to about 90 mole % of carbon dioxide evolved per molar equivalent of itaconic acid in said homopolymer based upon a maximum level of decarboxylation of 200 mole %.

5. A composition according to claim 1 wherein the average molecular weight of the decarboxylated polyitaconic acid homopolymer is from about 800 g/mole to about 5,000 g/mole.

6. A composition according to claim 1 wherein the composition comprises from about 0.1 to about 5% by weight of the composition of the polyitaconic acid homopolymer.

7. A composition according to claim 1 comprising a complexing agent selected from the group consisting of citric acid, its salts and derivatives thereof, methyl glycine diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof, and mixtures thereof.

8. A composition according to claim 1 comprising a complexing agent selected from the group consisting of citric acid and its salts, methyl glycine diacetic acid and its salts, and mixtures thereof.

9. A composition according to claim 1 comprising from about 10% to about 50% of a salt of methyl glycine diacetic acid by weight of the composition.

10. A composition according to claim 1 comprising an alkali metal carbonate.

11. A composition according to claim 1 wherein the composition comprises a dispersant polymer

12. A composition according to claim 1 wherein the composition comprises a carboxylated/sulfonated polymer.

13. A composition according to claim 1 wherein the composition comprises bleach.

14. A composition according to claim 1 wherein the composition comprises a bleach activator.

15. A composition according to claim 1 wherein the composition has a pH greater than 11 as measured in a 1% weight aqueous solution at 25° C.

16. A composition according to claim 1 comprising:
a) from about 0.1 to about 5% of the polyitaconic acid homopolymer;
b) from about 5 to about 40% by weight of the composition of a complexing agent;
c) From about 5 to about 40% by weight of the composition of an alkali metal carbonate;
d) an amylase and a protease;
e) from about 1 to about 30% by weight of the composition of bleach; and
f) from about 0 to about 10% by weight of the composition of a dispersant polymer.

17. A method of automatic dishwashing to improve glass and plastic clarity using a composition according to claim 1.
